(19) United States
(12) Patent Application Publication
(10) Pub. No.: US 2005/0004863 A1
(43) Pub. Date: Jan. 6, 2005

(54) Method for assessing and managing security risk for systems

(76) Inventor: Robert J. Havrilak, Minnetonka, MN (US)

Correspondence Address: ALTERA LAW GROUP, LLC, 6500 CITY WEST PARKWAY, SUITE 100, MINNEAPOLIS, MN, 55344-7704, US

(21) Appl. No.: 10/898,789

(22) Filed: Jul. 26, 2004

Related U.S. Application Data
(63) Continuation-in-part of application No. 10/426,469, filed on Apr. 29, 2003.

(51) Int. Cl. G06F 17/60

(52) U.S. Cl. 705/38

(57) ABSTRACT

A method, programmed digital computer and computer program product for assessing and managing security risks in an iterative fashion is provided. The invention is adaptable for use with any system with security targets that are accessible to a security threat. The invention is applicable to all systems with physical, electronic and virtual targets that can be accessed by a threat, thus creating a risk to the system, e.g., systems surrounding hospitals, blood banks, mass transit operations, power production and transmission facilities, communication systems, internet service providers, email and web hosting service providers, electronic commerce, financial institutions and school district lunch programs. Under the invention, if a security threat can access a security target within a system then a risk to the system is present. The invention provides an iterative process by which the system may be analyzed as an undivided whole or may, alternatively, be divided into discrete sections where all known security targets are identified within each section. All threats to each individual target are then identified and it is determined whether each threat has access to the associated target. If access is present, a qualitative or quantitative risk level is assigned. Then, appropriate countermeasures are considered and, where appropriate, implemented if the risk level is unacceptably high. A second inquiry is made regarding whether the particular threat has access to its identified target, considering the implemented countermeasure(s), and a second risk level assignment performed. If the risk level remains high, the process is repeated until the risk level for the subject target is acceptably low. All remaining targets are secured in this manner.

### RELATED APPLICATION(S)

The present application is a continuation-in-part of co-pending application entitled METHOD FOR ASSESSING AND MANAGING SECURITY RISK FOR SYSTEMS, filed by the same inventor under Ser. No. 10/426,469.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to security risk assessment and security risk management for systems.

### BACKGROUND OF THE PRESENT INVENTION

Risk analysis and risk management are well understood techniques. They are applied in a variety of fields and consist generally of a systematic application of policies, procedures and practices to the analysis, evaluation and control of risks. The risk analysis and management process generally involves the identification of particular hazards to a system, including raw materials, processes, work-in-process, finished goods and distribution. Known risk management processes generally suggest that a risk estimate be determined for individual hazards. The typical risk estimate is a function of the relative likelihood of its occurrence, the severity of harm resulting from the hazard's consequences and the exposure of people, equipment and inventory to the hazard. Once the risk estimate is established for a particular hazard, risk management focuses on controlling or mitigating the risk.

The literature is replete with references to various forms of industry-specific risk assessment and risk management tools. See, e.g., Guidance for Industry and FDA Premarket and Design Control Reviews—Medical Device Use-Safety: Incorporating Human Factors Engineering into Risk Management, Food and Drug Administration, Center for Devices and Radiological Health, Jul. 18, 2000; FAA System Safety Handbook, Chapter 15; Operational Risk Management, Dec. 30, 2000. However, these references, and others like them, are very often targeted to specific industries or tasks and, as a result, are particularly unsuitable for broad applicability. Moreover, these same references fail to disclose a process whereby the overall system risk is addressed in an efficient manner by dividing the overall system into manageable sections. Such an approach allows a more manageable and effective way to ensure the overall security of a complex system by partitioning the system into a series of discrete and easily manageable sections wherein the sections are secured individually as a means to ensuring the overall security of the system.

The same references also fail to disclose the iterative process whereby the effect of the control measure on the risk level is reassessed and the decision process to determine whether such risk level is acceptable is repeated. Under this process, if the risk level continues to be unacceptable, further control measures are implemented and the resulting risk reassessed until such risk becomes acceptable or is eliminated altogether for the subject system section. This iterative process then proceeds on a section-by-section basis until the entire system has been cleared of unacceptable levels of risk. The references also fail to focus on restricting or eliminating access of the identified hazard or threat to the associated target as the primary method of risk reduction or elimination.

Finally, other known security risk analysis and management tools known in the art provide what are essentially risk triangles, with each leg of the triangle representing a required component in order for a risk to be present. In such graphic representations of risk analysis and management, each element represented by a leg of the triangle must be present in order for a risk to be present. Elimination of one element is sufficient to remove the risk.

### SUMMARY OF THE INVENTION

No known risk triangle comprises Threat, Access and Target as contemplated by embodiments of the present invention whereby a primary focus is, in part, removal of the access of the threat to the target in order to mitigate the associated risk.

A method, computer program product and system for assessing and managing security risks in an iterative fashion is provided. The invention is adaptable for use with any system with security targets that are accessible to a security threat. The invention is applicable to systems with physical, electronic and virtual targets that can be accessed by a threat, thus creating a risk to the system. For example, the invention may be readily adapted for use in systems as diverse as hospitals, blood banks, mass transit operations, power production and transmission facilities, communication systems, internet service providers, email and web hosting service providers, electronic commerce, financial institutions and school district lunch programs.

A particular adaptation includes use of the invention to secure risks in the food manufacturing, production, processing, preparation and distribution industries. Another applicable industry grouping includes beverage manufacturing, processing and distribution. Yet another includes the home security industry.

Under the preferred embodiment of the invention, if a security threat can access a security target within a system then a risk to the system is present. Alternate embodiments of the invention provide an iterative process by which the system is either evaluated as a whole or, alternatively, initially divided into discrete and manageable sections and all known security targets are identified within each section.

If the system-wide approach is taken, then all targets within the system are identified, all threats identified and all points of access for the threats to the targets located. Then, through an iterative process and application of at least one countermeasure, the access for each threat to the targets is eliminated. Alternatively, if the sectioning approach is taken, then on a section-by-section basis all known threats to each individual target are identified and it is determined whether the individual threat has access to the associated target. If access is present, a risk level is assigned. The risk level may be qualitative or quantitative depending on the particular needs of the system. Following risk identification and risk level determination, appropriate countermeasures are considered to eliminate the access and, where appropriate, implemented if the risk level is unacceptably high. Then a second inquiry is made regarding whether the particular threat has access to its identified target, considering the implemented countermeasure(s), and a second risk level assignment performed. If the risk level is still unacceptably high, the process is repeated until the risk level for the subject target is acceptably low or eliminated altogether. The remaining targets within a given section are secured in this manner until the section itself is secured. The remaining sections are then successively and systematically secured under the inventive process. When all sections are secure, the entire system is deemed secure.

The restriction of access of threats to identified targets in the systems embodied, e.g., in the food and beverage manufacturing, processing and distribution industries, including facilities, processes, products, vendors and distribution networks is a primary focus of the present invention and is most efficient and effective way to manage risk within those industries.

An advantage of an embodiment of the invention is to provide a systematic security risk assessment and management tool for use in assessing and minimizing or eliminating risk to any system with a physical, electronic or virtual target that is susceptible to access and attack by a security threat.

An advantage of another embodiment of the invention is to provide a systematic security risk assessment and management tool for use in any industrial production and/or distribution system that is susceptible to external or internal risks that can be mitigated.

An advantage of another embodiment of the invention is to provide a security risk assessment and management tool intended for use in the food growing, processing, manufacturing, preparation and distribution industries.

An advantage of still another embodiment of the invention is to provide a security risk assessment and management tool intended for use in the beverage manufacturing, processing and distribution industries.

An advantage of another embodiment of the invention is to provide a security risk assessment and management tool intended for use in the home security industry.

An advantage of another embodiment of the invention is to provide a security risk mitigation method that is applied to subsections of the system so that when the risks have been mitigated across all subsections, the system risk is acceptable.

The foregoing advantages of various embodiments of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWINGS

FIG. 1 is a perspective of one embodiment for computerization of the method.

FIG. 2 is a flowchart of one embodiment of the security risk assessment and management method.

FIG. 3 is a screenshot of one embodiment of the security risk assessment and management method.

FIG. 4 is a screenshot of one embodiment of the security risk assessment and management method.

FIG. 5 is a screenshot of one embodiment of the security risk assessment and management method.

FIG. 6 is a screenshot of one embodiment of the security risk assessment and management method.

FIG. 7 is a screenshot of one embodiment of the security risk assessment and management method.

FIG. 8 is a screenshot of one embodiment of the security risk assessment and management method.

FIG. 9 is a flowchart of another embodiment of the security risk assessment and management method.

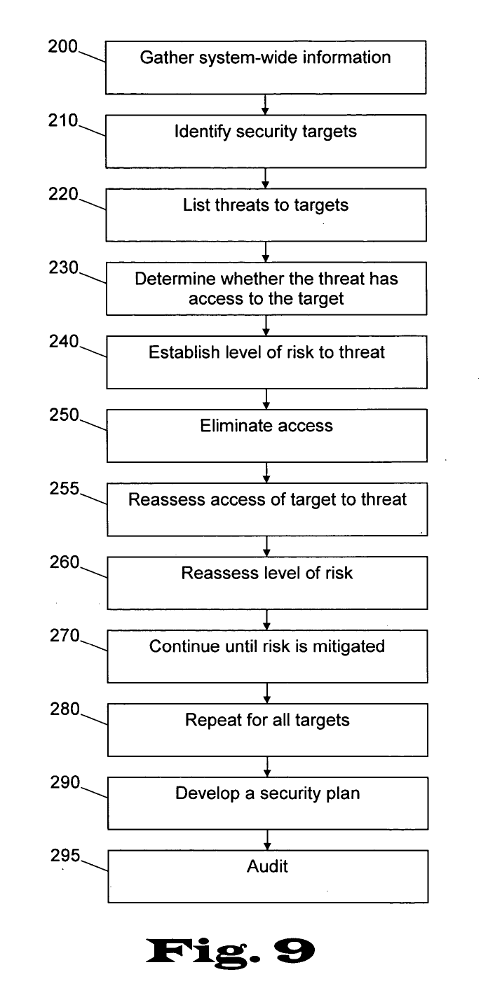

### DETAILED DESCRIPTION OF THE INVENTION

With reference to the accompanying Figures, there is provided a method for assessing and managing security risks to systems generally and in the food and beverage manufacturing, processing and distribution and water distribution industries specifically. It is understood that the iterative techniques disclosed herein have broad applicability to systems that have security targets embedded within the system that are vulnerable to attack from existing or potential threats.

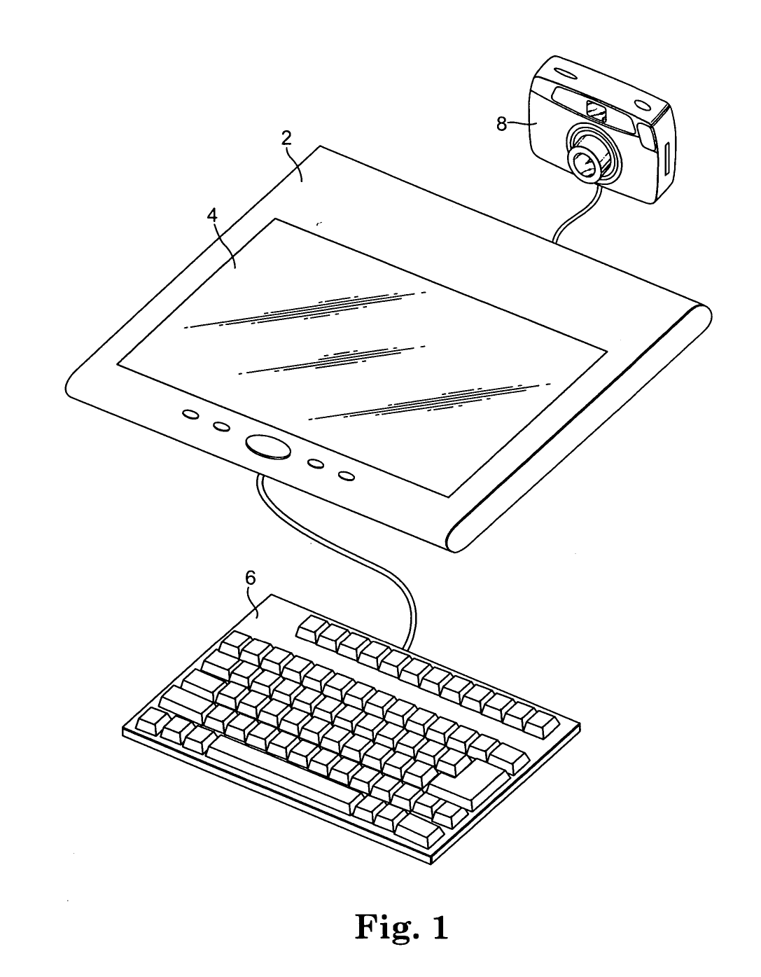

An embodiment of the invention as disclosed and claimed may be performed manually. As illustrated in FIG. 1, an alternate embodiment may be integrated into a workstation that includes: a programmed digital computer (2) having a processor, a memory operatively connected to the processor, and a data output interface operatively connected to the processor and memory; a display device (4) operatively connected to the computer and computer code that facilitates, documents and automatically generates and executes the inventive method.

As illustrated in FIG. 1, the preferred embodiment for the computer component of the system is a tablet personal computer (2) which may be used with or without the attached keyboard (6). This flexibility allows for easy mobility as the security evaluator moves throughout a physical system. However, implementation of the invention on other types of computers, e.g., desktop or laptop, is certainly within the scope of the invention. In addition, an embodiment of the system may include a built-in digital camera to facilitate documentation of certain targets and threats. The digital photos generated may be integrated into reports generated by the inventive system. Photos may be taken using an external camera (8) as shown in FIG. 1, and then electronically loaded into the computer (2).

The security risk assessment and security management invention disclosed herein applies to systems generally. The invention thus applies with equal force to systems as broad and diverse as hospitals, blood banks, mass transit operations, power production and transmission facilities, communication systems, internet service providers, email and web hosting service providers, electronic commerce, and school district lunch programs.

A particular adaptation includes use of the invention to secure risks in the food growing, manufacturing, production, processing, preparation and distribution industries. Another adaptation applies to the beverage manufacturing, processing and distribution industries. Still another adaptation applies to the home security industry.

To facilitate explanation, the best mode of the invention will be described in application to the food manufacturing, production, processing and distribution industries. In addition, selected screenshots from an embodiment of the invention as applied to food processing are included herein to facilitate understanding. It will be readily understood by one skilled in the art that the principles discussed in the particular instance have broad application to all systems generally.

Such systems are defined as including all aspects of an operation. Under the invention, the operational aspects may be evaluated as a systematic whole or, alternatively, organized into discrete sections to allow intensive examination of more complex systems in a systematic manner. For example, as applied to the exemplary food growing, manufacturing, production, processing, preparation and distribution industries, such system-sections may include facilities, personnel, operational processes, raw materials, work-in-process, finished goods, vendor operations, distribution networks and all personnel working within the system. Such sections may also include procedures relating to operations such as receiving, storage, reuse, packaging and distribution of raw materials, work-in-process and finished product.

According to the invention, security risks are comprised of three basic elements: a target, a threat to the target, and access for the threat to the target. An example of a target in the food industry is raw material storage. Raw material may be tampered with or contaminated during storage and, as a result, is a security target as contemplated by the present invention. Targets in other systems may include computer networks, computers, the blood supply, and electrical transmission lines.

An example of a threat to the target in the food industry example include employees or any other person having the ability to enter the raw material storage area. Additional examples of threats to the target raw material include contamination from the raw material container, contamination from external sources, i.e., air, either during transport or storage, a clean room operating below standards, contamination of the raw material by tainted water, etc. These exemplary threats also apply to the beverage manufacturing, processing and distribution industries. Threats in other non-food related systems may include computer hackers, computer virus developers, computer viruses, and the like.

The final element required to present a security risk under the invention is that the target must be accessible by a threat to the security of the associated target. Thus, in the particular example given above, any person having the ability to enter the area where the target raw material is stored is considered to have access and, under the inventive method, to be a threat to the target material and a security risk as a result. Examples of potential access of threats to targets in other non-food systems include individuals or groups gaining access to power production facilities, transmission lines, the water supply, the blood supply, or computers connected to the worldwide web for purposes of spreading a computer virus. The matrix of potential targets, threats and access points is seemingly endless.

In addition, it will be appreciated that any given target will likely have several potential threats associated with it. It will also be appreciated that individual sections within a system will likely contain multiple security targets, each target having multiple associated security threats. Thus, the overall system security risk can be seen as a combination of all target/threat combinations within all sections within the overall system.

A primary focus of the inventive process is to organize the elimination or minimization of the security risk by systematically eliminating or restricting all access points of threats to the associated targets. This may be done either on a system wide basis or, alternatively, on a section-by-section basis.

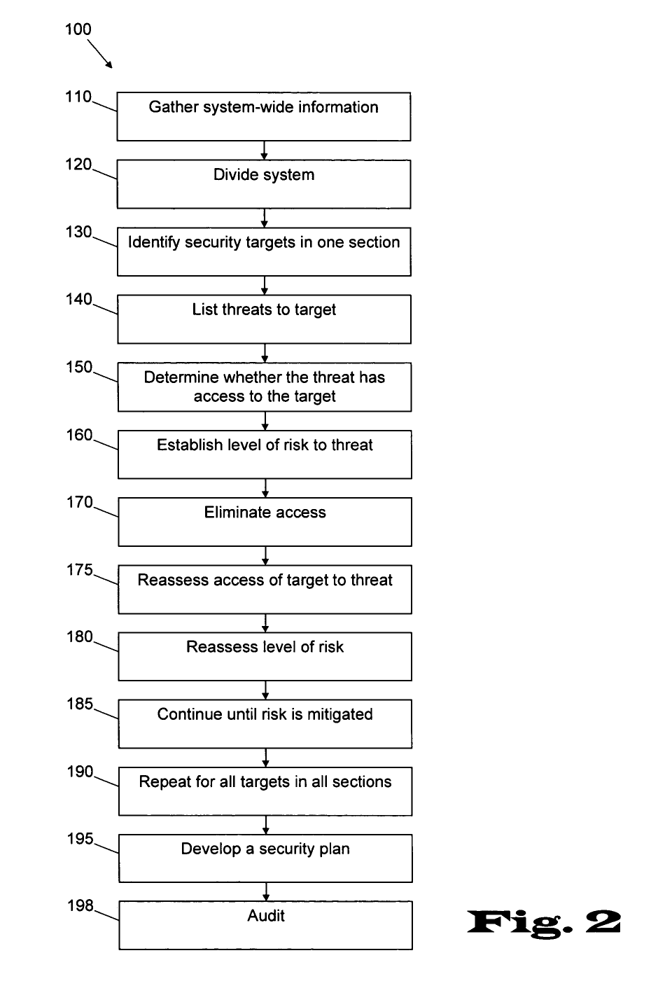

With reference to FIG. 2, the section-by-section basis embodiment of the inventive method (100) is illustrated. The method begins with the gathering and analysis of all relevant system-wide information (110). This information may be used to assist in identifying security targets, possible threats, and potential access points for the threats to the targets. As discussed above, the invention will be described in connection with particular application to the food manufacturing, production, processing and distribution industries. However, one skilled in the art will readily ascertain the broad and diverse applicability of the invention to security of systems generally.

The system-wide information gathered may, in the particular case of the food industry, include site plans, personnel information, identification of all personnel having access to the product and process at any phase of the operation, past criminal history near the system, past security incident reports, any past recall incidents, existing countermeasures for threats or hazards to the system and the like.

The inventive system allows any number of digital photos of subject targets to be integrated into the system using a built-in digital camera. Alternatively, electronic images of targets may be imported into the system. Further, notes may be taken and electronically integrated into the system for consideration and inclusion in the risk elimination and minimization phase.

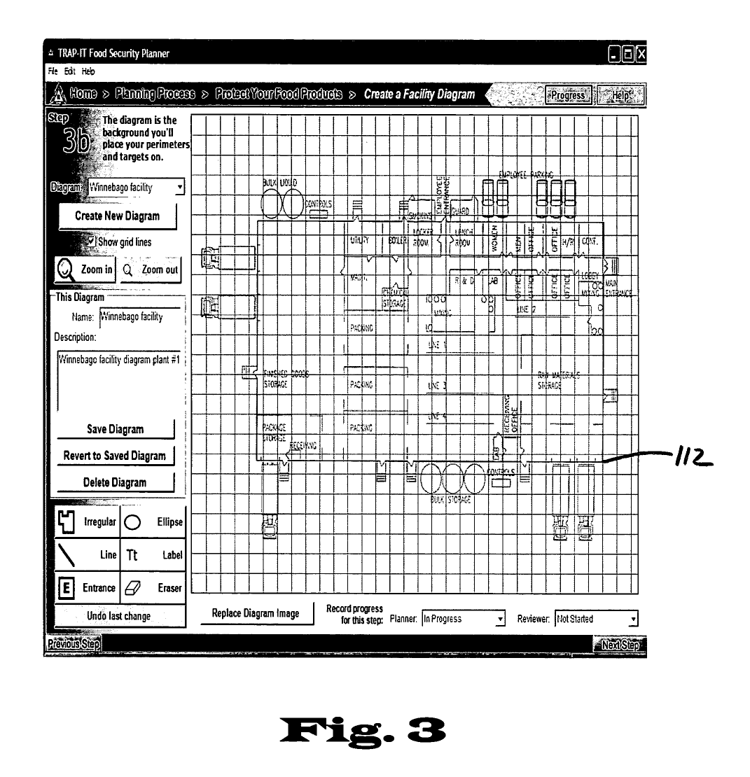

The information-gathering step (110) may result in the generation of a system diagram. In the food processing example, a facility diagram(s) may be generated outlining the perimeter of each facility and identifies relevant areas and processes contained therein. FIG. 3 illustrates such an exemplary food industry facility diagram (112).

The diagram should be large enough to encompass all areas of the subject facility and be sufficiently detailed to allow differentiation of potential threats, targets and access points. The system/facility diagram may be manually drawn using tools well known in the art or, alternatively, an existing electronic image may be used. The inventive system allows either possibility.

Once the system-wide information is assembled and analyzed, the system may be, according to the instant embodiment, divided into very discrete and manageable components or sections (120). A system section is defined herein as a subpart of the overall system. Individual circumstances and the complexity of the system will dictate the scope of the section ultimately selected for analysis and security risk mitigation. By way of example, in the food manufacturing, production, processing and distribution industry, a section may be defined as the raw material incoming/receiving process. Alternatively, if the raw material incoming/receiving process is too complicated to be considered as a whole, it may be further divided into a raw material receiving section, a raw material inspection section and a raw material testing section.

Without such sectioning, the risk assessment may be too cumbersome for most complex systems and thus may result in unidentified or latent threats, allowing unnecessary risk to remain in the system. The sectioning and subsequent systematic focus on targets and threats embedded therein greatly reduces the likelihood of unmitigated latent risks within the system. The mitigation of the overall system risk is accomplished according to the invention by identifying and either eliminating or mitigating the security risks in an individual section to an acceptable level. Once each individual section is secured, the overall system is deemed secure.

Returning now to FIG. 2 and continuing with the sectioning embodiment of the invention, when the individual discrete sectioning is complete, the security risk assessment focuses on one section at a time to identify all targets in that section according to the invention. Thus, all existing or potential known secured and unsecured security targets within an individual section of the system are identified and documented (130).

The targets may be identified manually, or with aid of a programmed digital computer as illustrated in FIG. 1. The computer-aided method may compile a list of a plurality of security targets in response to at least one query. The list of targets may be stored in the computer's memory. The list of targets may, in part, be derived from a target database accessible to the computer. The database may be local. The targets thus identified may be documented manually or the data may be alternatively integrated into the inventive system; either possibility allows for the integration of a photograph of the targets, digital or otherwise.

Example targets in the specific food industry example may be moveable or immovable and include: opened, uncovered or accessible bins, bags, buckets, barrels, totes or tanks that contain unsecured food raw material or products. Additional targets include opened or uncovered process equipment such as vessels, kettles, piping, tanks, silos or conveyors with unsecured access ports or man-ways. Targets not having tamper resistant packaging or covering may be particularly appropriate for identification under the inventive method.

Any existing countermeasures in place at this stage of the method may be documented. All targets identified at this stage of the method may be marked on the facility diagram.

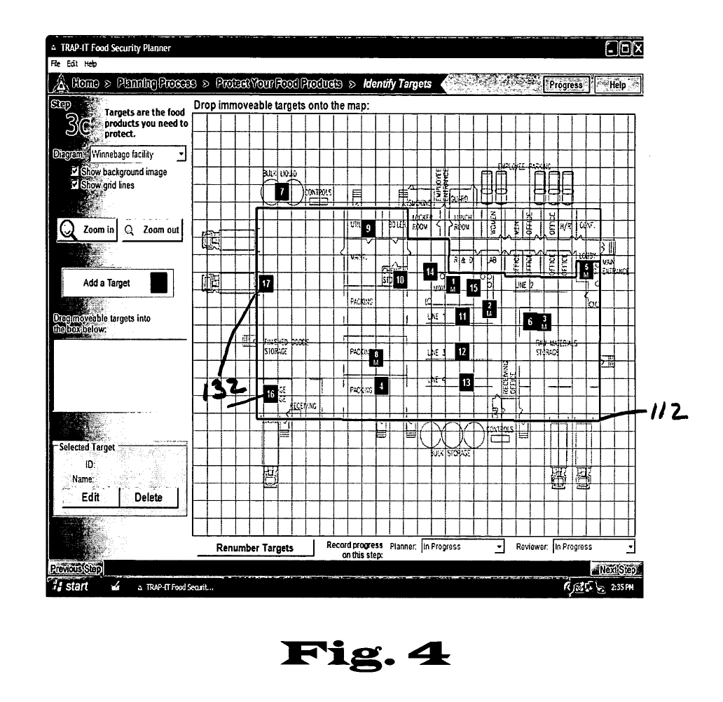

FIG. 4 illustrates the facility diagram (112) with identified targets marked thereon with uniquely numbered black squares (132).

Next, all existing or potential known threats to a particular target are identified and documented (140). As described above, an embodiment of the inventive system allows digital photos using a built-in digital camera, or importation of existing photos, and written notes to fully define and describe the identified threat. The threats may be identified manually or with aid of a programmed digital computer. The computer-aided method may result in the computer compiling a list of a plurality of threats in response to at least one query. The list of threats may be stored in the computer's memory. The list of threats may, in part, be derived from a database of threats which may be local and accessible to the computer.

The inventive system may then associate the information for each identified threat with the information for the relevant target for documentation and analysis purposes. Any existing countermeasures encountered during this stage of investigation should be documented. The threats identified during this stage of the method may be marked on the facility diagram.

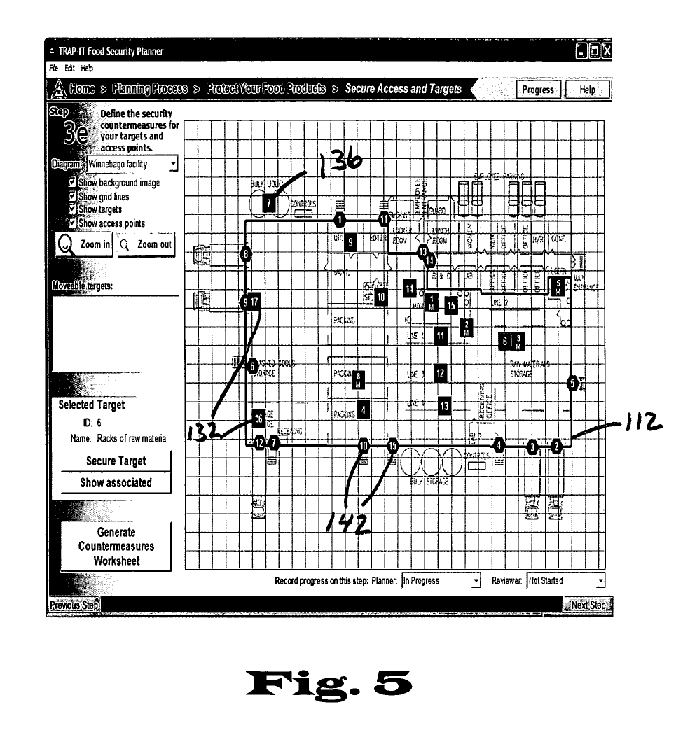

FIG. 5 illustrates the facility diagram (112) with the building's perimeter drawn in with identified targets (numbered black squares) (132), and access points to the targets contained within the perimeter (numbered black hexagons) (142).

With reference again to FIG. 2, a determination is then made regarding whether each identified threat has access to the associated target (150), considering all relevant existing countermeasures that were previously identified during the system-wide information gathering stage (110), target identification stage (130), and threat identification stage (140). All access points identified via the method may be marked on the facility diagram to facilitate elimination of such access.

If the threat has access to the target, a value may be assigned to the associated level of risk (160), or it may be simply be noted that access exists for a particular threat. The countermeasure identification may be done manually or with aid of a programmed digital computer. The computer-aided embodiment may compile a list of countermeasures in response to at least one query and may store the countermeasure list in the computer's memory. The listing may, in part, be derived from a countermeasures database which may be local and that is accessible by the computer.

Obviously, if a threat cannot access a target, there is no, or negligible, risk. However, when a threat has access to a target, a risk is present. The level of risk may be qualitative, e.g., high, medium, low, or yes/no or qualitative depending on the particular importance of the system, or section thereof. Individual sections within a system may be treated differently in terms of level of risk assessment in that system sections of high or critical importance may be assessed quantitatively while other non-critical sections may be assessed qualitatively.

If the individual level of risk for a given target is determined to be unacceptably high, countermeasures may be implemented to mitigate the risk by either restricting or eliminating the access of the threat to the target (170). There are at least two possible security strategies that may be employed at this point. The first is a perimeter-based view of target access elimination via countermeasures. Under this strategy, the ultimate countermeasure(s) selected may focus on securing the identified targets within a secure perimeter or may consolidate targets into areas that may be protected within a secure perimeter, thus creating a secured environment. In the specific food industry example, this may mean that uncovered raw material targets are moved within a room with a secured perimeter. A second strategy is to employ a target-based security strategy whereby the access to individual targets is eliminated on a target-by-target basis. In the specific food example, this may entail covering exposed raw material targets.

Further specific targets may require a combination of the two strategies, i.e., the exposed raw materials are covered and assembled within a room with a secured perimeter. By way of example, FIG. 5 illustrates such a combination. Target #7, bulk liquid storage (136), is located outside the building's perimeter. Thus, the facility may require a combination of perimeter-based security and target-based security to achieve an acceptable level of risk. As one skilled in the art will readily recognize, these access identification and elimination strategies have broad applicability to systems outside the specific food industry example. Regardless of the strategy(ies) selected, the inventive system provides a medium for documentation and specification of the countermeasures used to secure each identified target.

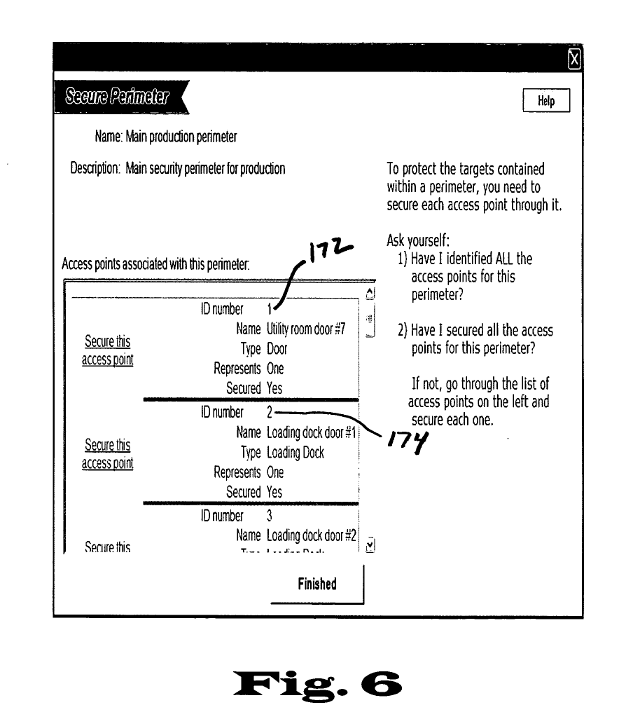

FIG. 6 illustrates an embodiment of the invention regarding providing detail for individual access points. In the screenshot, the access points utility room door #7 (172) and loading dock door #1 (174), both located on the perimeter boundary, are indicated as secured.

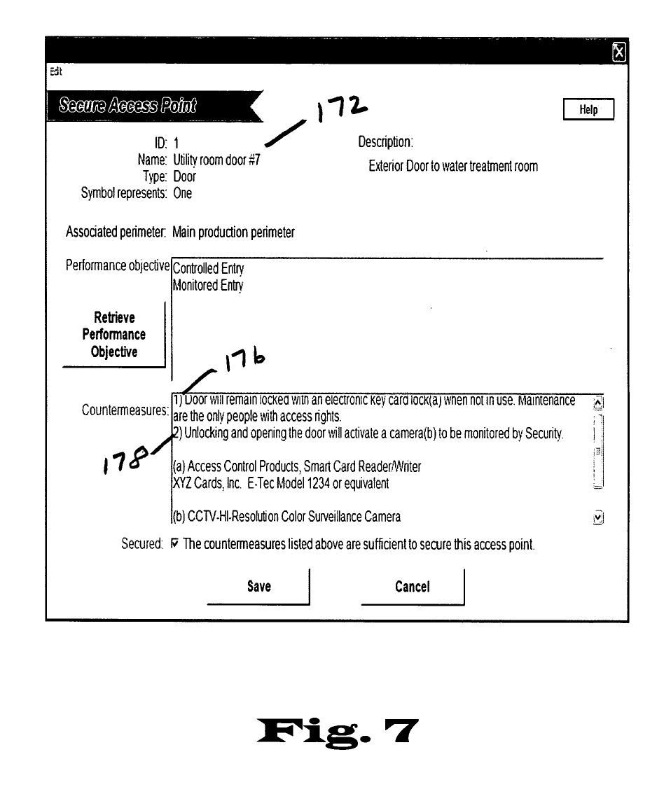

FIG. 7 provides detail regarding a portion of the countermeasures implemented to obtain security for access point #7 (utility room door on the perimeter) (172) for the example embodiment. For example, countermeasure number 1 provides for the door to remain locked with an electronic key card lock (176). Further, maintenance personnel are the only persons allowed access. Countermeasure number 2 provides that opening the utility room door will activate a camera that is monitored by security personnel (178).

As will be discussed, an embodiment of the inventive system may also provide the operator with feedback regarding whether the specific countermeasure adequately addressed the risk due to the access of the threat to the particular target.

Under a preferred embodiment of the invention, the individuals identified as having access to any part of the facility, product or process may be viewed generally as threats and, as a result, each such individual may be assigned some form of security clearance under adopted security clearance procedures as a particular example of a countermeasure. Examples of such security clearance levels are well known in the art and include:

Full Access: This level provides full unrestricted access to the facility. Individuals assigned this clearance are recognized by facility management and risk assessors as being absolutely trustworthy.

Escorted Access: This level provides access with minimal security clearance. Individuals assigned this clearance must be accompanied by an escort with full access security clearance.

Supervised Access: This level provides access only when the facility is staffed with personnel having full access security clearance.

Restricted Access: This level provides access only to specified areas of the facility, product or process that are clearly marked. Movement to or from the restricted areas may only occur under escort.

Denied Access: Access to the facility, product or process is denied. This is the default clearance assigned to all entry applicants until their assigned security clearance is upgraded.

Discretionary Access: Personnel may, at their discretion, assign a special security clearance exemption, with any access rules they feel appropriate.

Once the countermeasures are implemented, a follow-up determination is made to determine whether the target is still accessible to the threat (175) and the resulting level of risk reassessed (180). If the level of risk still remains unacceptably high, additional countermeasures are implemented to eliminate or restrict the access of the threat to the target (170), and the access of the target to the threat (175) and the resulting risk level (180) reevaluated in an iterative fashion until the risk level becomes acceptably low (185). The inventive system allows for placement of secured and unsecured targets to be placed on the previously integrated system diagram. Secured and unsecured targets are differentiated on the system diagram by, e.g., color. Secured targets may be indicated as black while unsecured targets are red to provide feedback to the individuals working on the security plan. Following application of additional countermeasures to the unsecured targets, and determination that the risk level is now acceptable, the inventive system modifies the unsecured (red) target to a secured (black) target.

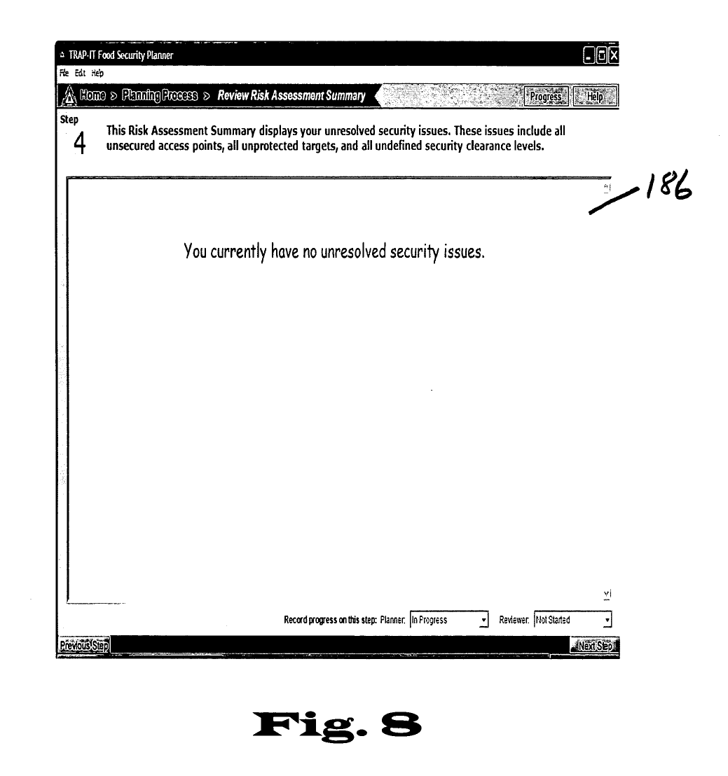

Ultimately, a risk assessment summary (186) may be provided as illustrated by FIG. 8. Here, the system confirms that there are no unresolved security issues. In other words, each individual accessible target has been successfully protected by at least one countermeasure.

Returning now to FIG. 2, each individual target with a discrete system section is addressed in the iterative manner described above until all the risks associated with all threatened targets within an individual section have been reduced to an acceptable level or eliminated altogether and the individual section has been secured. Under the invention, one then proceeds to the next system section and the iterative process is repeated until all threatened targets in all sections have been secured (190). At this point, the entire system is secure. The inventive system provides a security model that displays the system diagram, a summary of the system targets, and the associated access points and further the security status of all targets by affirmatively identifying unsecured targets requiring adequate countermeasures.

Once the security model adequately addresses each identified target and indicates that the system is secure, a security plan may be developed to document each identified target, the mode of access to the target by the threat, the levels of risk for each threatened target, the associated countermeasures implemented to eliminate or restrict access of the threat to the target thus mitigating the risk, and the final risk level for each target (195). The inventive system generates this security plan automatically based upon the information previously identified and integrated. In essence, such a security plan serves as a specification document to be used by the system security administrator as a tool to maintain and improve the system's security.

The security plan may be audited to on a periodic basis to ensure compliance with the implemented countermeasures and to ensure the security of the individual system sections as well as the system as a whole (198). The inventive system may generate audit forms automatically to focus the auditor on individual sections and each target and associated countermeasure contained therein.

In an alternate embodiment, individual section threat levels may be established after the gathering and analysis of system-wide information and the division of the system into discrete sections is complete. A section threat level may be either a quantitative or qualitative assignment of risk to one or more sections in the system. In certain instances, it is understood that some systems may have individual sections that are of more critical importance than others and, as a result, may require different risk assessment and management approaches than other less critically important sections. For example, an organization may consider a system section dealing with work-in-process to be more critical or more vulnerable to security risks than a distribution section might be. Thus, the work-in-process section may be assigned a quantitative section threat level of high while the distribution section may be assigned a section threat level of low. A section threat level of high will receive a greater level of scrutiny in the security risk assessment and management inquiry than will a section threat level of low. In the example, the work-in-process section will receive a much higher degree of scrutiny under the inventive method in terms of identifying targets, threats to the targets and access of the threat to the target than will the distribution section. A number of factors influencing the decision regarding whether a section threat level should be established for an individual section(s) within the system, e.g., history of past security incidents in connection with the section, number and education level of person coming into contact with the section activities, etc.

Alternatively, a geographic location threat level may be established by assigning a threat risk level to one or more individual locations within the system. A location threat level is either a qualitative or quantitative assignment of threat level risk for one or more locations within the system. For example, an organization may consider a location where the food formulation and preparation occurs to be more critical or more vulnerable to security risks than a finished product distribution center location. Again, this determination is based upon a variety of factors. Thus, the formulation and preparation may be assigned a quantitative location level of high or medium and the finished good distribution center location assigned a location threat level of low. A location threat level of high will receive a greater level of scrutiny in the security risk assessment and management inquiry than will a location threat level of low. Thus, in the example, the formulation and preparation location will be reviewed much more closely for targets, threats to the targets and access of the threat to the target than will the distribution center location.

The location threat level may be established following the assembly and analysis of system-wide information and the division of the system into discrete and manageable sections. Whether such an approach is preferred is entirely subjective and is dependent upon a number of factors including, e.g., needs of the system administrators, criminal activity near the particular location, history of past security incidents in the area, the physical layout and complexity of the facility in the location. As with the section risk level, location risk levels may be assigned qualitative or quantitative values. Additionally, as with the section risk level, only a subset of all locations may be required to have a location risk threat level assigned.

Turning now to FIG. 3, the embodiment discussing the invention as applied to the system as a whole, without sectioning, will be briefly discussed. The method may begin with the gathering of system-wide information (200) as with regard to the sectioning embodiment of the invention. Security targets are identified (210), threats to targets identified and listed (220) and it is determined whether the threat has access to the identified targets (230) as discussed above.

A level of risk may be established for those threats having access to a target (240). At least one countermeasure may then be implemented to eliminate such access (250). Then, the access of the threat to the target is reevaluated (255) and the relevant risk level reassessed (260). If the risk is not sufficiently eliminated, at least one additional countermeasure may be applied and then the access and corresponding risk level again determined. This iterative process may be repeated until all risk is mitigated (270) for at least one target. This process is repeated for all targets (280) until the risk level for the overall system is deemed appropriately mitigated. A security plan may then be developed (290) that details the targets, threats, access points and countermeasures. The security plan may be periodically audited (295) to ensure the plan is adequately protecting the system from risks.

The above specification describes certain preferred embodiments of this invention. This specification is in no way intended to limit the scope of the claims. Other modifications, alterations, or substitutions may now suggest themselves to those skilled in the art, all of which are within the spirit and scope of the present invention. It is therefore intended that the present invention be limited only by the scope of the attached claims below:

1. A method for assessing and managing security risks to a system, the method comprising:
identifying a plurality of security targets within the system;
identifying a plurality of threats to at least one of the plurality of security targets creating at least one identified threat;
determining whether each identified threat may access the at least one of the plurality of security targets; and
reporting the security risks comprising each identified threat with access to at least one of the plurality of security targets.

2. The method of claim 1, further comprising:
applying at least one countermeasure to eliminate access of each identified threat to at least one of the plurality of security targets.

3. The method of claim 2, further comprising:
determining whether each identified threat still has access to the at least one of the plurality of security targets after application of the at least one countermeasure; and
applying at least one additional countermeasure to eliminate access of each identified threat determined to still have access to at least one of the plurality security targets.

4. The method of claim 3, further comprising:
repeating the steps of determining whether each identified threat has access to the at least one of the plurality of security targets and applying of at least one additional countermeasure in an iterative manner to eliminate access of all identified threats to all of the plurality of security targets.

5. The method of claim 1, further comprising:
gathering at least one of background information, operational information, infrastructure information, process information, vendor information, product information and information regarding existing security risk countermeasures.

6. The method of claim 1, wherein the step of identifying a plurality of security targets comprises compiling answers from a series of queries.

7. The method of claim 1, wherein the step of identifying a plurality of threats comprises compiling answers from a series of queries.

8. The method of claim 1, further comprising:
dividing the system into a plurality of sections;
applying at least one countermeasure to restrict access of each identified threat to at least one of the plurality of security targets on a section-by-section basis; and
repeating the steps of determining and applying in an iterative manner on a section-by-section basis to further restrict access of each identified threat to each of the plurality of security targets.

9. The method of claim 1, further comprising providing a risk level for each of the plurality of security targets.

10. The method of claim 1, further comprising providing a risk level for the system.

11. The method of claim 1, further comprising providing a qualitative risk level for each of the plurality of security targets.

12. The method of claim 1, further comprising providing a quantitative risk level for each of the plurality of security targets.

13. The method of claim 1, further comprising providing a qualitative risk level for the system.

14. The method of claim 1, further comprising providing a quantitative risk level for the system.

15. The method of claim 8, further comprising providing a qualitative risk level for each of the plurality of sections of the system.

16. The method of claim 8, further comprising providing a quantitative risk level for each of the plurality of sections of the system.

17. The method of claim 1, further comprising documenting the plurality of security targets, each identified threat, and the security risks of each identified threat to the associated one of the plurality of security targets.

18. The method of claim 2, further comprising auditing the system periodically to ensure the at least one countermeasure continues to function to eliminate access of each identified threat to at least one of the plurality of security targets.

19. The method of claim 1, wherein the step of identifying a plurality of security targets comprises making a graphical representation of possible access point to at least one of the plurality of security targets.

20. The method of claim 1, wherein the reporting step further comprises making a graphical representation of an access point for the at least one identified threat to at least one of the plurality of security targets.

21. A method for assessing and managing security risks to a system, the method comprising:
identifying a plurality of security targets within the system;
identifying threats to at least one of the plurality of security targets creating identified threats;
determining whether the identified threats may access at least one of the plurality of security targets associated with at least one of the identified threats;
reporting security risks comprising those identified threats with access to at least one of the plurality of security targets;
applying at least one countermeasure to eliminate access of each identified threat to at least one plurality of security targets;
repeating the step of determining whether the identified threats may access at least one of the plurality of security targets and the step of applying of at least one countermeasure in an iterative manner to eliminate the access;
providing a risk level for the system;
documenting the plurality of security targets, identified threats, and access of each identified threat to the associated one of the plurality of security targets; and
auditing the system periodically to ensure the at least one countermeasure continues to function to eliminate access of the identified threats to the associated one of the plurality of security targets.

22. The method of claims 1, 8 or 21, wherein the plurality of security targets comprise security targets in at least one of food growing, food manufacturing, food processing, food distribution and food preparation industries.

23. The method of claim 22, wherein the plurality of security targets are not tamper evident.

24. The method of claim 22, wherein the identified threats comprise at least one person.

25. The method of claims 1, 8 or 21, wherein the plurality of security targets comprise security targets in at least one of beverage manufacturing, beverage processing, and beverage distribution industries.

26. The method of claim 25, wherein the plurality of security targets are not tamper evident.

27. The method of claim 25, wherein the threats comprise at least one person.

28. The method of claims 1, 8 or 21, wherein the plurality of security targets comprises home security targets.

29. The method of claim 28, wherein the identified threats comprise at least one person.

30. A programmed digital computer for assessing and managing security risks to a system, the system having a plurality of security targets and a plurality of threats to the targets, comprising:
a processor;
a memory operatively coupled to the processor;
a data input interface operatively coupled to the memory; and
a data output interface operatively coupled to the memory;
wherein the programmed digital computer operates to pull a list of the plurality of security targets in response to at least one query and to store the list of the plurality of security targets in the memory;
wherein the programmed digital computer operates to pull a list of the plurality of threats to the targets in response to at least one query and to store the list of the plurality of threats in the memory;
wherein the programmed digital computer operates to determine at least one access of the plurality of threats to the plurality of targets in response to at least one query; and
wherein the programmed digital computer operates to report the security risks comprising the access of the plurality of threats to the plurality of targets.

31. The programmed digital computer of claim 30, wherein the list of the plurality of targets comprises security targets that are not tamper evident.

32. The programmed digital computer of claim 30, further comprising the programmed digital computer operating to determine at least one countermeasure to limit the access of at least one of the plurality of threats to at least one of the plurality of targets.

33. The programmed digital computer of claim 32, further comprising the programmed digital computer operating to access a database of countermeasures.

34. The programmed digital computer of claim 33, further comprising the database being local.

35. The programmed digital computer of claim 30, wherein the determining of access of the plurality of threats to the plurality of targets comprises making a graphical representation of at least one of a plurality of access points to at least one of the plurality of targets.

36. The programmed computer of claim 30, wherein the reporting of security risks graphically displays at least one access in relation to at least one of the plurality of targets.

37. The programmed computer of claim 30, wherein the system comprises at least one of food manufacturing, food processing and food distribution.

38. The programmed computer of claim 37, wherein the security targets are not tamper evident.

39. The programmed computer of claim 30, wherein the system comprises at least one of beverage manufacturing, beverage processing and beverage distribution.

40. The programmed computer of claim 39, wherein the security targets are not tamper evident.

41. The programmed computer of claim 30, wherein the security targets comprise home security system targets.

42. The programmed computer of claim 30, further comprising a digital camera operatively connected to the computer.

43. A computer program product for assessing and managing security risk to systems having a plurality of security targets and a plurality of security threats to the targets, comprising:
computer code for documenting and facilitating identifying a plurality of security targets;
computer code for documenting and facilitating listing a plurality of threats to at least one of the plurality of security targets;
computer code for documenting and facilitating evaluating at least one threat's access to the plurality of security targets; and
computer code for generating a report including security risks comprising the access of the plurality of threats to the plurality of security targets.

44. The computer program product of claim 43, further comprising computer code for applying at least one countermeasure to eliminate the access of at least one of the plurality of threats to the plurality of security targets.

45. The computer program product of claim 44, further comprising computer code for determining whether each identified threat still has access to the plurality of security targets after application of the at least one countermeasure; and applying at least one additional countermeasure to eliminate the access of each of the plurality of threats to the plurality of security targets for those ones of the plurality of threats determined to still have access to at least one of the security targets.

46. The computer program product of claim 45, further comprising computer code for determining whether the at least one additional countermeasure for the ones of the plurality of threats determined to still have access to at least one of the plurality of security targets have eliminated the access; and
repeating the step of applying at one further countermeasure to the threats to eliminate the access of those ones of the plurality of threats determined to still have access to at least one of the security targets.

47. The computer program product of claim 43, further comprising computer code for generating a series of queries and compiling answers thereto to facilitate the identifying of a plurality of security targets within the system.

48. The computer program product of claim 43, further comprising computer code for generating a series of queries and compiling answers thereto to facilitate the identifying of a plurality of threats to the at least one identified security target within the system.

49. The computer program product of claim 43, further comprising computer code for dividing the system into sections.

50. The computer program product of claim 49, further comprising computer code for:
applying at least one countermeasure to eliminate the access of each one of the plurality of threats to the plurality of security targets on a section-by-section basis; and
ensuring that the at least one countermeasure eliminates the access of each identified one of the plurality of threats to the associated security targets on a section-by-section basis.

51. The computer program product of claim 43, further comprising computer code for providing a risk level for each identified one of the plurality of security targets.

52. The computer program product of claim 43, further comprising computer code for providing a risk level for the system.

53. The computer program product of claim 49, further comprising computer code for:
dividing the system into sections and identifying a plurality of security targets and a plurality of security threats having access to the security targets on a section-by-section basis; and
implementing countermeasures to eliminate access of the plurality of security threats to the plurality of security targets on a section-by-section basis.
